(19) United States
(12) Patent Application Publication
(10) Pub. No.: US 2014/0375593 A1
(43) Pub. Date: Dec. 25, 2014

(54) Capacitive Touch Sensor Control Unit With Automatic Gain Control

(71) Applicant: Tajeshwar Singh, Klaebu (NO)

(72) Inventor: Tajeshwar Singh, Klaebu (NO)

(21) Appl. No.: 13/923,592

(22) Filed: Jun. 21, 2013

(51) Int. Cl. G06F 3/041; G06F 3/044

(52) U.S. Cl. CPC G06F 3/0416; G06F 3/044
USPC 345/174

(57) ABSTRACT

In one embodiment, a touch sensor having automatically adjustable gain control includes an amplifier coupled to a first sense line of a touch sensor. The amplifier receives a signal from the first sense line and scales the signal by an amount of gain. An analog-to-digital (ADC) converter receives the signal from the amplifier and converts the signal from an analog signal to a first digital signal. A processor receives the first digital signal from the ADC and, without user input, automatically calculates the amount of gain for scaling the signal based on the received first digital signal. A feedback loop transmits the amount of gain to the amplifier for applying the amount of gain to the signal.

### TECHNICAL FIELD

This disclosure generally relates to touch screen technology.

### BACKGROUND

A touch position sensor can detect the presence and location of a touch by a finger or by another object, such as a stylus. A touch position sensor, for example, can detect the presence and location of a touch within an area of an external interface of the touch position sensor. In a touch sensitive display application, the touch position sensor enables direct interaction with what is displayed on the screen, rather than indirectly with a mouse or touch pad.

There are a number of different types of touch position sensors, such as resistive touch screens, surface acoustic wave touch screens, capacitive touch screens, etc. Touch position sensors can be attached to or provided as part of devices with a display, such as computers, personal digital assistants, satellite navigation devices, mobile telephones, portable media players, portable game consoles, public information kiosks and point of sale systems. Touch position sensors have also been used as control panels on appliances.

### BRIEF DESCRIPTION OF THE DRAWINGS

For a more complete understanding of the present disclosure and its features and advantages, reference is now made to the following description, taken in conjunction with the accompanying drawings, in which:

FIG. 1 illustrates an example system comprising a capacitive touch sensor coupled to a control unit.

FIG. 2 illustrates an example system comprising a capacitive touch sensor control unit for automatically adjusting the gain for amplifying a signal within a capacitive touch sensor.

FIG. 3 illustrates an example method for automatically adjusting the gain for amplifying a signal within a capacitive touch sensor.

### DESCRIPTION OF EXAMPLE EMBODIMENTS

In particular embodiments of a touch sensor having automatically adjustable gain control, an amplifier is coupled to a first sense line of a touch sensor and receives a signal from the first sense line. The amplifier scales the signal by an amount of gain to amplify the signal. An analog-to-digital (ADC) converter receives the signal from the amplifier and convert the signal from an analog signal to a first digital signal. A processor receives the first digital signal from the ADC and automatically calculates the amount of gain for scaling the signal without user input. A feedback loop transmits the amount of gain to the amplifier for applying the amount of gain to the signal.

Providing automatic gain control in a touch-sensor may result in various technical advantages. One technical advantage may be the ability to provide a touch sensor that is capable of detecting the location of a touch object without requiring user input of a gain amount. For example, the touch sensor may be automatically adjusted via a feedback loop without requiring user input. As a result, a more adaptive system may be provided than prior systems Another technical advantage may be that integrating circuits may be incorporated into the backend of the system rather than the front end. For example, in certain embodiments, a sigma delta analog-to-digital converter may be used to measure the difference between two signals to improve the conversion of the voltage signal to the representative digital signal with little or no loss. Because the sigma delta analog-to-digital converter may include one or more integrating circuitry or integrators that collect charge from the signal, such circuitry may be omitted from the amplifier. As a result, the system may have a simplified front end. Additionally, the system may be made smaller and at a reduced cost. Embodiments of the present disclosure may include all, some, or none of the above benefits.

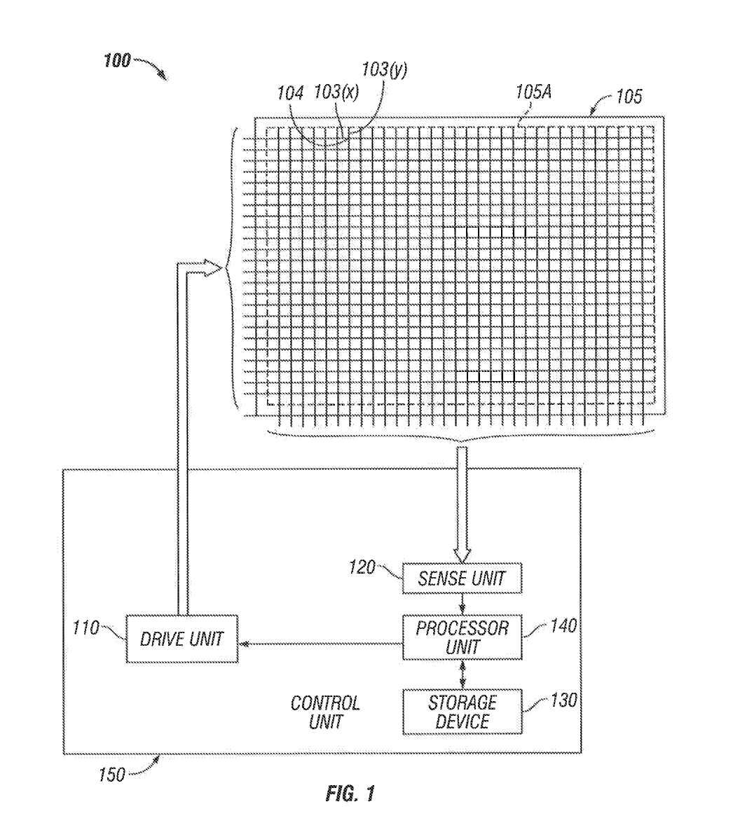

FIG. 1 illustrates an example system 100 comprising a capacitive touch sensor 105 coupled to an example control unit 150. Touch sensor 105 and control unit 150 may detect the presence and location of a touch or the proximity of an object within a touch-sensitive area 105A of touch sensor 105. Herein, reference to a touch sensor may encompass both the touch sensor and its control unit, in particular embodiments. Similarly, reference to a control unit may encompass both the control unit and its touch sensor, in particular embodiments.

In particular embodiments, control unit 150 may include a drive unit 110 comprising a pulse driver configured to generate an electrical pulse for transmission to the touch sensor 105. As will be described in more detail below, touch sensor 105 may include an array of capacitive nodes. When an object touches or comes within proximity of a capacitive node, a change in capacitance may occur at the capacitive node and control unit 150 may measure the change in capacitance, for example, as a change in the amount of charge needed to raise the voltage at the capacitive node by a pre-determined amount By measuring changes in capacitance throughout the array, control unit 150 may determine the position of the touch or proximity within the touch-sensitive area(s) 105A of touch sensor 105. This disclosure contemplates any suitable form of capacitive touch sensing, in particular embodiments.

Capacitive touch sensor 105 of system 100 may include a screen comprising an insulator coated with a transparent conductor in a particular pattern. When a finger or other object touches the surface of the screen, there is a change in capacitance. A signal indicating this change in capacitance may be sent to control unit 150 for processing to determine the position of the touch. In various embodiments, system 100 is operable to process measurements of any suitable type of capacitance, such as surface capacitance, projected capacitance, mutual capacitance, and self or absolute capacitance.

As depicted, capacitive touch sensor 105 includes sensing area 105A. Drive electrodes 103(x) and sense electrodes 103(y) may be formed in the sensing area 105A on one or more substrates. As depicted, the drive electrodes 103(x) run in a horizontal direction and the sense electrodes 103(y) run in a vertical direction. However, the sense and drive electrodes may have any suitable shape and arrangement. Capacitive sensing channels 104 may be formed in the sensing area at the regions where edges of the drive electrodes 103(x) and sense electrodes 103(y) are adjacent. In certain embodiments, drive electrodes 103(x) and sense electrodes 103(y) are arranged in electrical isolation from each other. For example, the drive electrodes 103(x) and the sense electrodes 103(y) of capacitive touch sensor 105 may be arranged on opposite surfaces of an insulating substrate so that the substrate provides electrical isolation between the drive and sense electrodes.

The control unit 150 of system 100 may be in communication with the capacitive touch sensor 105. As depicted, the control unit 150 includes a drive unit 110, a sense unit 120, a storage device 130, and a processor unit 140. The storage device 130 may store programming in a computer-readable storage medium for execution by the processor unit 140 and data used in or resulting from operations of the processor unit 140. In some embodiments, the control unit 150 is an integrated circuit chip such as a general purpose microprocessor, a microcontroller, a programmable logic device/array, an application-specific integrated circuit (ASIC), or a combination thereof. In other embodiments, the drive unit 110, the sense unit 120, and/or the processor unit 140 may be provided in separate control units.

The processor unit 140 controls the drive unit 110 to supply drive signals (such as electrical pulses) to the drive electrodes 103(x), so as to induce charge on the sense electrodes 103(y) that intersect with the drive electrodes 103(x). The sense unit 120 senses charge at the various intersections 104 via the sense electrodes 103(y), and the sense unit 120 provides measurement signals representing node capacitance to the processor unit 140.

In a particular embodiment, the processor unit 140 is capable of processing data received from the sense unit 120 and determining the presence and location of a touch on the capacitive touch sensor 105. In a particular embodiment, the presence and location of a touch on the capacitive touch sensor 105 may be determined by detecting a change in capacitance of one or more capacitive sensing channels 104 of the capacitive touch sensor. In some embodiments, the capacitance of one or more capacitive sensing channels 104 may he sampled periodically in order to determine whether the capacitances of the channels have changed.

In typical systems, in order to sense the capacitance of a capacitive sensing channel, an amplifier is used to amplify the signal measured from sense lines 103(y). The current may be scaled using an amount of gain that is added to the signal to ensure adequate amplification while preventing saturation of the signal. In such systems, however, the amount of gain must be selected by a user for the particular type of touch screen being used. Additionally, such amplifiers typically include integrating circuitry for collecting charge from the sense lines. Accordingly, such systems are more complex on the front end and are not adaptable without user input.

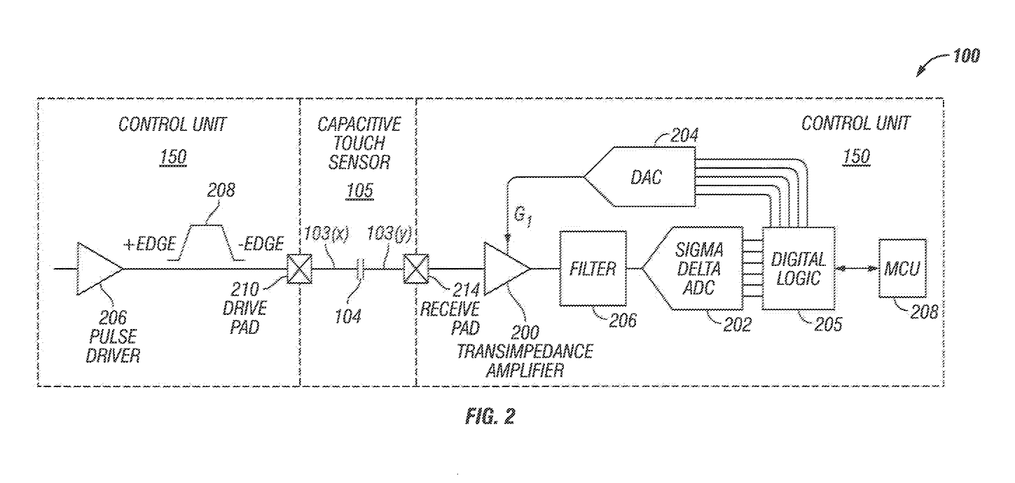

FIG. 2 illustrates system 100 of FIG. 1 further comprising a transimpedance amplifier (TIA) 200 with automatic gain control. Though touch sensor 105 may include any appropriate number and combination of drive lines and sense lines coupled for differential measurements. For ease of illustration, however, FIG. 2 illustrates the architecture of any two sense lines in touch sensor 105. Touch sensor 105 is depicted as including a drive line X 103(x) and a sense line V 103(y) separated by a capacitive sensing channel 104. In some embodiments, control unit 150 includes a TIA 200 and a sigma delta analog-to-digital converter (ADC) 202. A feedback loop 204 and digital logic 205 provides for automatic adjustment of the gain applied by TIA 200.

As shown in FIG. 2, system 100 further comprises a pulse driver 206, drive pad 210, receive pad 214, current conveyer 216, timing circuit 218, switches 220 and 222, and differential output 228. Pulse driver 206 is operable to generate electrical pulses 208 that each comprise a positive (i.e., rising) edge and a negative (i.e., falling) edge. In between the positive and negative edges, the pulse may remain generally constant for a period of time (i.e., at a high value after the positive edge and a low value after the negative edge). An electrical pulse 208 may be transmitted to a capacitive touch sensor 105 via drive pad 210. In various embodiments, drive pad 210 is coupled to a drive line 103(x) of the capacitive touch sensor 105. Drive pad 210 is operable to allow transmission of the electrical pulse 208 to the drive line 103(x).

The electrical pulse 208 is transmitted to one side of a capacitive sensing channel 104 of the capacitive touch sensor. The positive and negative edges of the electrical pulse 208 may induce a charge shift on the opposite side of the capacitive sensing channel 104. In some embodiments, the opposite side of the capacitive sensing channel 104 is coupled to a sense line 103(y) of the capacitive touch sensor 105. The sense line 103(y) is coupled to receive pad 214 of control unit 150. The charges induced by the edges of electrical pulse 208 may result in a current through receive pad 214 and amplifier 200 of control unit 150. A positive edge of electrical pulse 208 may result in current flowing through the receive pad and toward amplifier 200. A negative edge of electrical pulse 208 may result in current flowing in the opposite direction.

Control unit 150 includes an amplifier 200 that includes any appropriate combination of components, amplifiers, and/or circuitry operable to amplify a signal measured from sense line 103(y). In some embodiments, adjustable gain amplifier 200 includes a transimpedance amplifier (TIA) with adjustable gain control. Specifically, TIA 200 may be operable to receive an amount of current from receive pad 214, scale the current by an amount of gain, shown as G1, convert the current to a voltage, and allow the amplified voltage to flow towards ADC 202. In particular example embodiments, the gain factor, or G1, may be ½, ¼, ⅛, or some other appropriate scaling factor that is appropriate. Scaling the current by G1 ensures that enough amplification is provided without saturating the signal. Previous touch sensor control units that included programmable gain amplifiers required a user to input the G1 that would be used to scale the signal the particular kind or type of touch screen 105. In contrast, control unit 150 comprises an adjustable gain amplifier such as TIA 200 that is automatically adjusted via a feedback loop 204 without requiring user input. Because G1 can be automatically adjusted as needed, control unit 150 provides a more adaptive system that prior systems that required a user to set the amount of gain.

As illustrated, control unit 150 includes a filter 206. In certain embodiments, filter 206 may comprise a high frequency noise filter to provide rejection of out of signal band noise. In certain embodiments, filter 206 may be programmable such that it may be set to match the desired frequency so as to filter out any noise outside the desired frequency. As such, filter 206 may improve the quality of the signal received from TIA 200. It is generally recognized, however, that filter 206 is optional and may be omitted from system 100.

Control unit 150 includes an analog-to-digital (ADC) converter 202 that includes any appropriate combination of components and/or circuitry to convert the voltage signal received from TIA 200 or filter 206 to a digital signal. In certain embodiments, the ADC 202 includes a sigma delta ADC 202. The sigma delta ADC 202 may measure the difference between two signals to improve the conversion of the voltage signal to the representative digital signal with little or no loss. In certain embodiments, sigma delta ADC 202 may include one or more integrating circuitry or integrators that collect charge from the signal. As just one example, the integrating circuits may be programmed to track the capacitance of touch sensor 105. The capacitance of touch sensor 105 may, for example, depend on the size, shape, and/or other characteristics of touch sensor 105. Integrating circuits may be designed to track touch sensor 105 capacitances in logarithmic steps according to the output of ADC 202. Because integration occurs within the ADC 202, it is generally recognized that the amplifier, such as TIA 200, is not required to include integrating circuits. As a result, TIA 200 provides a simplified front end for touch screen 105. Because the complexity of the system is reduced, the signal to noise ration may be reduced. Additionally, the system may be made smaller and at a reduced cost.

Control unit 150 includes digital logic 205 that includes any appropriate combination of hardware and/or software components and/or circuitry to calculate the required gain, G1, to be provided to TIA 200. In certain embodiments, digital logic 205 receives the signal from ADC 202 and compares the signal to a desired level. Specifically, digital logic 205 may operate to increase or decrease G1 to minimize the difference between the signal received from ADC 202 and the desired level. The calculated G1 is transmitted via a feedback loop 204 that may include a digital-to-analog converter that operates to convert the digital signal to an analog signal that is introduced to TIA 200 as G1.

Control unit 150 includes a micro-controller unit (MCU) 208 that includes any appropriate combination of components and/or circuitry to determine the location of touch objects proximate to touch sensor 105 based on the capacitance of sensing channel 104. In operation, MCU 208 determines locations of touch objects proximate to touch sensor 105 using differential measurement on the sense line(s) 103(y) of touch sensor 105. Specifically, pulse driver 206 may transmit a drive signal on the 103(x), and MCU 208 may sense and/or measure the capacitances represented on sense lines 103(y). In certain embodiments, the presence and location of a touch on the capacitive touch sensor 105 may be determined by detecting a change in capacitance of one or more capacitive sensing channels 104 of the capacitive touch sensor.

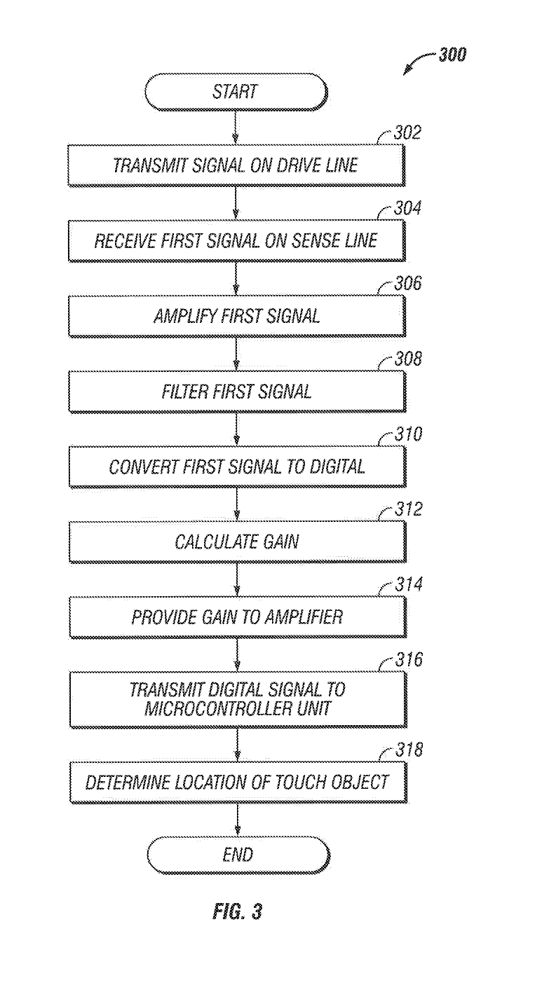

FIG. 3 illustrates an example method 300 of operating a touch sensor 105 using differential sensing. At step 302, touch sensor control unit 150 may transmit a drive signal on drive line 103(x) of touch sensor 105. Touch sensor control unit 150 may successively drive pulses one ach of the drivelines of touch sensor 105, such that each drive line may be pulsed in succession in a repeating cycle. After each pulse of a given drive line 103(x), touch-sensor control unit 150 may detect the resulting signals on the sense lines 103(y) of touch sensor 105. Based on the charges, touch sensor control unit 150 may detect the sense line 103(y) proximate to a touch object. Thus, touch sensor 105 may determine a particular 103(x),103(y) coordinate of the touch object.

After pulsing a drive signal, at step 304, a first signal may be received on a first sense line 103(y) of touch sensor 105. At step 306, touch sensor control unit 150 may amplify the current received from sense line 103(y). In certain embodiments, a TIA amplifier may be used to convert the current to voltage and an amount of gain may be added to scale the signal. The amount of gain may be selected automatically by a microprocessor based on the signal received by TIA 200.

After the signal is amplified, it may be filtered, at step 308, to reduce out of signal band noise. At step 310, the filtered analog signal may be converted to a digital signal by a ADC 202. In certain embodiments, the ADC 202 includes integrating circuitry for accumulating charge representing the capacitance of sense line 103(y). At step 312, the output of ADC 202 may be transmitted to digital logic 205, which may operate to calculate G1 for adapatively adjusting the gain provided to TIA 200. At step 314, the calculated G1 may be transmitted via feedback loop 204 to TIA 200 for use in amplifying received signals.

After steps 310-314 are completed, the output of the integrating circuitry of ADC 202 may be transmitted to MCU 208 at step 316. At step 318, MCU 208 may determine a location of a touch object proximate to touch sensor 105 based on the differential measurements taken on two or more sense lines 103(y). Method 300 may then return to step 302 where another drive signal may be pulsed on another drive line 103(x).

Herein, reference to a computer-readable storage medium encompasses one or more non-transitory, tangible computer-readable storage media possessing structure. As an example and not by way of limitation, a computer-readable storage medium may include a semiconductor-based or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. An touch sensor having automatically adjustable gain control, comprising:
an amplifier coupled to a first sense line of a touch sensor, the amplifier operable to receive a signal from the first sense line and scale the signal by an amount of gain;
an analog-to-digital (ADC) converter coupled to the amplifier, the ADC configured to receive the signal from the amplifier and convert the signal from an analog signal to a first digital signal,
a processor coupled to the ADC, the processor configured to:
receive the first digital signal from the ADC; and
based on the first digital signal received by the processor, calculate the amount of gain for scaling the signal, the amount of gain calculated automatically and without user input; and
a feedback loop coupling the processor and the amplifier, the feedback loop configured to transmit the amount of gain to the amplifier for applying the amount of gain to the signal.

2. The apparatus of claim 1, wherein the amplifier comprises a transimpedance amplifier (TIA).

3. The apparatus of claim 2, wherein the ADC comprises a sigma-delta ADC, the sigma-delta ADC comprising an integrator configured to collect charge from the digital signal and output the digital signal to the at least one processor, wherein integration occurs in the ADC and not the TIA.

4. The apparatus of claim 1, wherein the feedback loop comprises a digital-to-analog converter configured to convert the amount of gain to an analog gain signal for application to the signal.

5. The apparatus of claim 1, further comprising a filter coupled between the amplifier and the ADC, the filter configured to filter out an amount of noise outside a desired signal band.

6. The apparatus of claim 1, wherein processor is further operable to:
measure the difference between the first digital signal associated with the first sense line of the touch sensor with a second digital signal associated with a second sense line of the touch screen; and
determine a location of a touch object proximate to the touch sensor based on the difference between the first digital signal of the first sense line and the second digital signal associated with the second sense line.

7. The apparatus of claim 1, wherein the processor is further operable to:
calculate a difference between the first digital signal and a desired level of signal; and
increase or decrease the amount of gain applied by the amplifier to minimize the difference between the first digital signal and the desired level of signal.

8. A method comprising:
receiving a signal from a first sense line of a touch sensor;
scaling the signal by an amount of gain to amplify the signal;
converting the signal from an analog signal to a first digital signal,
based on the first digital signal and without user input, automatically calculating the amount of gain for scaling the signal; and
transmitting the amount of gain to the amplifier for application to the signal.

9. The method of claim 8, wherein receiving the signal comprises receiving the signal by a transimpedance amplifier (TIA) coupled to the first sense line of the touch sensor.

10. The method of claim 9, wherein converting the signal from the analog to the digital signal comprises:
converting, by a sigma-delta ADC, the analog signal to the digital signal; and
collecting the charge by an integrator of the sigma-delta ADC such that integration occurs in the sigma-delta ADC and not the TIA.

11. The method of claim 8, wherein transmitting the amount of gain to the amplifier comprises:
converting the amount of gain to an analog gain signal; and
applying the analog gain signal to the signal.

12. The method of claim 8, further comprising filtering out an amount of noise outside a desired signal band.

13. The method of claim 8, further comprising:
measuring the difference between the first digital signal associated with the first sense line of the touch sensor with a second digital signal associated with a second sense line of the touch screen; and
determining a location of a touch object proximate to the touch sensor based on the difference between the first digital signal of the first sense line and the second digital signal associated with the second sense line.

14. method of claim 8, further comprising:
calculating a difference between the first digital signal and a desired level of signal; and
increasing or decreasing the amount of gain applied by the amplifier to minimize the difference between the first digital signal and the desired level of signal.

15. A system comprising:
a capacitive touch sensor comprising a plurality of sense lines; and
a control unit coupled to the capacitive touch sensor, the control unit comprising:
an amplifier coupled to a first sense line of a touch sensor, the amplifier operable to receive a signal from the first sense line and scale the signal by an amount of gain;
an analog-to-digital (ADC) converter coupled to the amplifier, the ADC configured to receive an analog signal from the amplifier and convert the analog signal to a first digital signal,
a processor coupled to the ADC, the processor configured to:
receive the first digital signal from the ADC; and
based on the first digital signal received by the processor, calculate the amount of gain for scaling the signal, the amount of gain calculated automatically and without user input; and
a feedback loop coupling the processor and the amplifier, the feedback loop configured to transmit the amount of gain to the amplifier for applying the amount of gain to the signal.

16. The system of claim 15, wherein:
the amplifier comprises a transimpedance amplifier (TIA); and
the ADC comprises a sigma-delta ADC, the sigma-delta ADC comprising an integrator configured to collect charge from the digital signal and output the digital signal to the at least one processor, wherein integration occurs in the ADC and not the TIA.

17. The system of claim 15, wherein the feedback loop comprises a digital-to-analog converter configured to convert the amount of gain to an analog gain signal for application to the signal.

18. The system of claim 15, further comprising a filter coupled between the amplifier and the ADC, the filter configured to filter out an amount of noise outside a desired signal band.

19. The system of claim 15, wherein processor is further operable to:
measure the difference between the first digital signal associated with the first sense line of the touch sensor with a second digital signal associated with a second sense line of the touch screen; and
determine a location of a touch object proximate to the touch sensor based on the difference between the first digital signal of the first sense line and the second digital signal associated with the second sense line.

20. The system of claim 15, wherein the processor is further operable to:
calculate a difference between the first digital signal and a desired level of signal; and
increase or decrease the amount of gain applied by the amplifier to minimize the difference between the first digital signal and the desired level of signal.
